(19) United States
(12) Patent Application Publication
(10) Pub. No.: US 2016/0128504 A1
(43) Pub. Date: May 12, 2016

(54) EGG PREPARATION ASSISTANCE DEVICE

(71) Applicant: Linsey Rosland, Hinsdale, IL (US)

(72) Inventor: Linsey Rosland, Hinsdale, IL (US)

(21) Appl. No.: 14/938,765

(22) Filed: Nov. 11, 2015

Related U.S. Application Data
(60) Provisional application No. 62/078,200, filed on Nov. 11, 2014.

(51) Int. Cl. A47J 29/06

(52) U.S. Cl. CPC A47J 29/06

(57) ABSTRACT

An assistance device for use with preparing eggs that enables a large number of eggs to be cooked simultaneously as well as reduces the risk of cracked or broken eggs. The assistance device includes one or more securing components that are flexible or adjustable to accommodate eggs of various configurations in terms of size and shape. The assistance device further enables simple and easy transferring of cooked eggs to and from a pan of boiling water.

### CROSS- REFERENCE TO RELATED APPLICATIONS

This application claims priority to U.S. Provisional Patent Application No. 62/078,200 filed Nov. 11, 2014, which is incorporated herein by reference.

### FIELD OF THE INVENTION

The present invention generally relates to the field of cooking utensils. More specifically, the present invention relates to a device that assists in the preparation of boiled eggs.

### BACKGROUND OF THE INVENTION

An egg is a versatile food that can be prepared in a variety of ways. For example, a popular preparation is boiling eggs for a certain period of time. A soft-boiled egg has firmly set whites, but a soft runny yolk. In contrast, a hard-boiled egg has both firmly set whites and yolk.

At least two traditional methods may exist for boiling eggs. Eggs may be prepared by a method termed for the purposes of this invention as a “cold start”. A cold start is used to boil eggs by placing the eggs into a pot or pan, covering the eggs with cool water, and bringing the water to a boil. This method, however, may crack or break the eggs when the eggs are put into the pot.

Alternatively, eggs may be prepared by a method termed for the purposes of this invention as a “hot start”. A hot start may be used to boil eggs by bringing water in a pot or pan to a boil before placing the eggs in the pot. This method, however, may crack or break the eggs as well as splash hot water when the eggs are put into the pot.

Once the water reaches a boil (100° C.), the eggs remain in the water to cook for a specific period of time to achieve the eggs desired preparation, i.e., 3-6 minutes for soft-boiled eggs and 10-15 minutes for hard-boiled eggs. The hot water is then drained from the pot and the eggs removed, or the pot is removed from heat and both the water and eggs are set aside to cool. Additionally, the eggs may be ran under or submerged in cool water to stop cooking. The boiled eggs may then be peeled by cracking and removing the shell.

One issue with the typical methods for boiling eggs is that most pans are limited in the number of eggs the pan can accommodate for cooking. This is problematic when a large number of eggs are desired to be cooked simultaneously such as during Easter observances when eggs are prepared for decorating.

Another issue with the typical method for boiling eggs is that sometimes the eggs crack or break as a result from eggs hitting one another or the interior of the pan. For example, cracking or breaking may occur when eggs are placed in the pan, during cooking, or as a result from draining the eggs, e.g., pouring eggs from the pan into a strainer.

Although devices exist for boiling eggs, no device exists that solves all of the problems discussed above.

### SUMMARY OF THE INVENTION

This invention introduces an assistance device for use with preparing eggs. The device may be used with any cooking apparatus capable of heating liquid, for example, a pot or a pan or even a bowl. According to the invention, the device is placed within a cooking apparatus filled with liquid or fluid such as water. In certain embodiments, a cover or lid may be used with the cooking apparatus such that a lid may be placed on top of both the egg preparation assistance device and the pot.

It is contemplated that water may be brought to a boil by placing the cooking apparatus above a heating element such as a flame of a stove or using a microwave appliance.

According to the invention, the egg preparation assistance device includes individual securing components for each egg. Being that eggs are generally ovoid-shaped (three-dimensional version of an oval), the securing components comprise surfaces that are formed as a portion of an ovoid shape. Each securing component is flexible or adjustable to accommodate eggs of various configurations in terms of size and shape. More specifically, an internal surface of the securing component conforms to the surface of an egg.

The device is configured such that it is easy to hold and maneuver such as positioning into and out of a pot of water. According to one embodiment, the device may include one or more handles that may further be heat resistant so that pot holders are not required.

The device may also include hole elements for draining water. This eliminates the need to pour the eggs from the pan into a strainer risking cracking or breaking of the eggs. A user may simply remove the device including cooked eggs from the pot (such as by its heat resistant handles). Once the device is removed from the pan, the water drains from the hole elements.

The device, including cooked eggs, may then be simply transferred. For example, the device including eggs may be placed under cool running water or submerged in a pool of cold water. As another example, the device including eggs may be placed directly on a countertop or within a refrigerator.

The device may be manufactured from any material that can withstand hot or boiling water without compromising the integrity of the device. Examples of heat resistant materials may include polymers such as silicone, metal, plastic, ceramic, or any synthetic or semi-synthetic material, to name a few. It is also contemplated that different components or elements of the device may be constructed of different materials. For example, the handle component may be constructed of one material that is different from the material from which the body is fabricated.

The device provides many advantages such as enabling a large number of eggs to be cooked simultaneously. For example, the device may accommodate a dozen (12) eggs but any number of eggs is contemplated.

Another advantage of the device is that it secures eggs allowing them to be more easily introduced to and/or removed from hot or boiling water.

A further advantage of the device is that it eliminates the need to drain the water from the pan. Thus, the water may be reused.

The invention and its attributes and advantages will be further understood and appreciated with reference to the accompanying drawings.

### BRIEF DESCRIPTION OF THE DRAWINGS

The preferred embodiments of the invention will be described in conjunction with the appended drawings provided to illustrate and not to limit the invention, where like designations denote like elements, and in which:

FIG. 1 illustrates an isometric view of an egg preparation assistance device according to one embodiment of the invention.

FIG. 2 illustrates a side view of the egg preparation assistance device according to the invention.

FIG. 3 illustrates a top view of the egg preparation assistance device according to the invention.

FIG. 4 illustrates a bottom view of the egg preparation assistance device according to the invention.

FIG. 5 illustrates a section view of the egg preparation assistance device according to the invention.

FIG. 6 illustrates a section view of the egg preparation assistance device as used with a cooking apparatus according to the invention.

### DETAILED DESCRIPTION

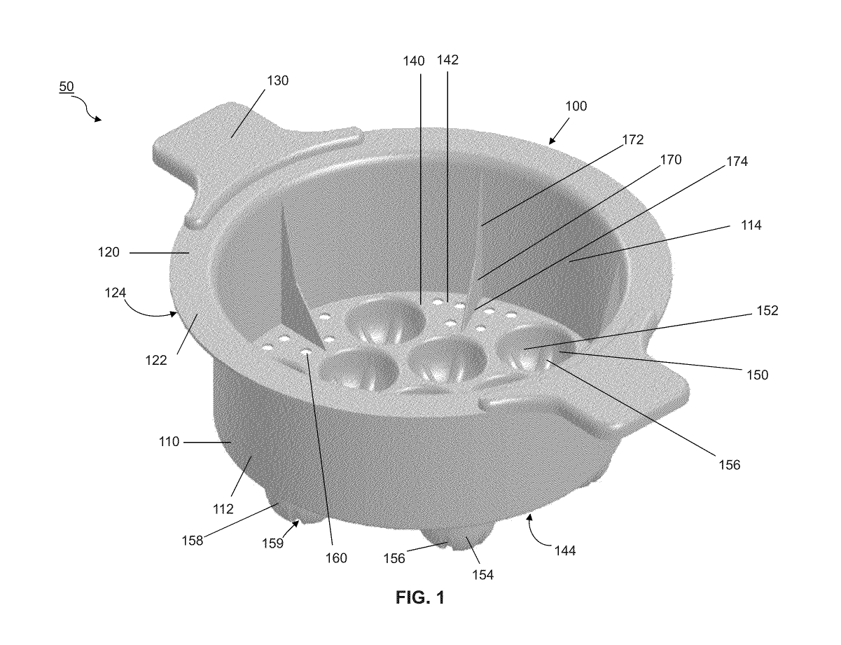

The present invention is generally directed to a cooking utensil that assists in the preparation of boiled eggs. The figures illustrate different views of the device according to the invention. As can be seen in FIG. 1 through FIG. 5, the egg preparation assistance device 50 includes a body 100. As shown, the body 100 is configured as a semi-spherical shape, however, any shaped body is contemplated

The body 100 includes at least a side wall element 110 connected to a base wall element 140. The side wall element 110 includes an outer surface 112 and an inner surface 114 and the base wall element 140 includes an interior surface 142 and an exterior surface 144.

The body 100 may also include a border element 120 connected to the side wall element 110. The border element 120 allows placement of the assistance device 50 within a cooking apparatus. As an example, the border element 120 may rest on the top rim of a cooking apparatus such that the device 50 does not become entirely submerged in hot water making it difficult to be removed by a user. The border element 120 further comprises a top surface 122 and a bottom surface 124.

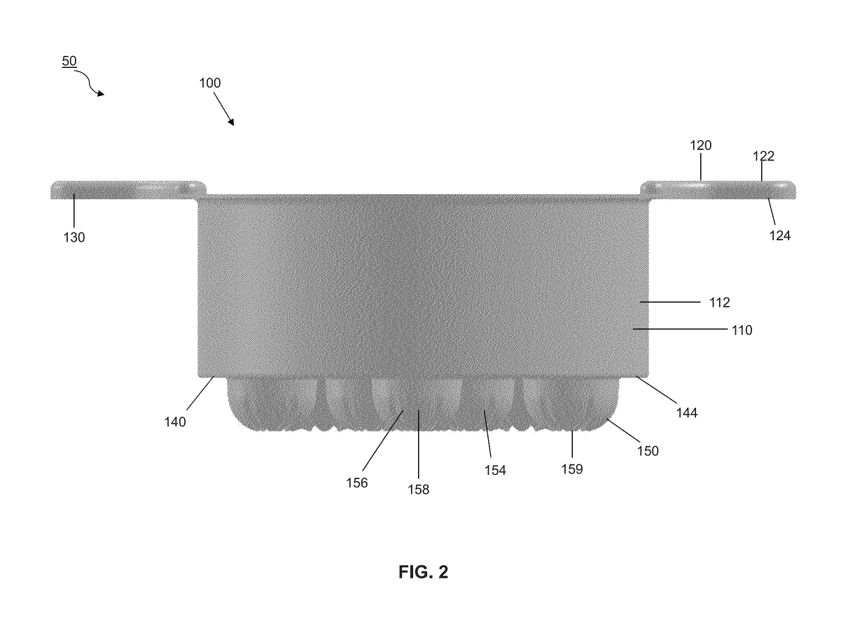

In certain embodiments, the device 50 may include a handle component 130. As shown in FIG. 1 and FIG. 2, the handle component 130 is positioned on the top surface 122 of the border element 120. It is also contemplated that a handle component 130 may be attached to the body 100 such via a hinge-type mechanism so that the handle component 130 may be folded inward/outward toward the body 100.

The body 100 includes one or more securing components 150 and one or more hole elements 160. More specifically, the securing component 150 is positioned on the base wall element 140. The securing components 150 are configured to securely position eggs within the body 100 of the device 50. Each securing component 150 is flexible or adjustable to accommodate eggs of various configurations in terms of size and shape.

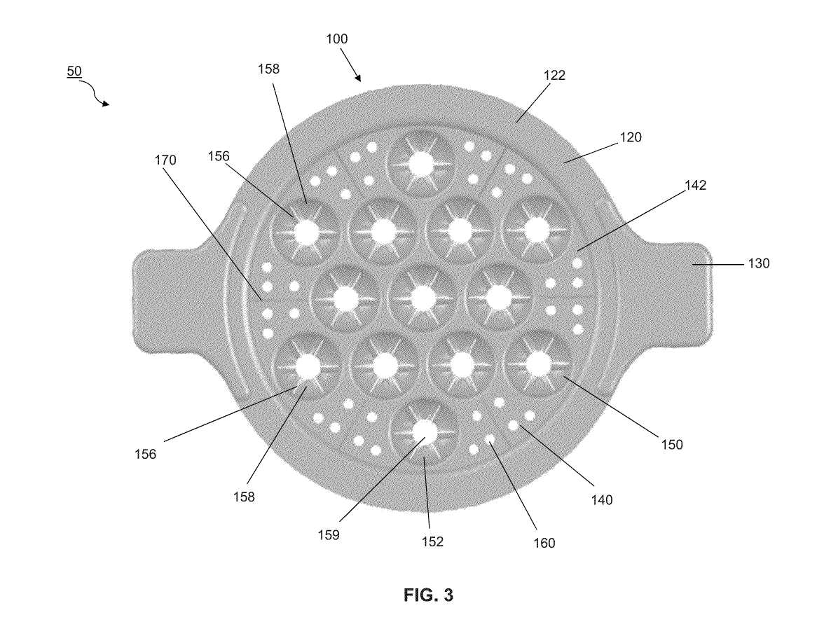

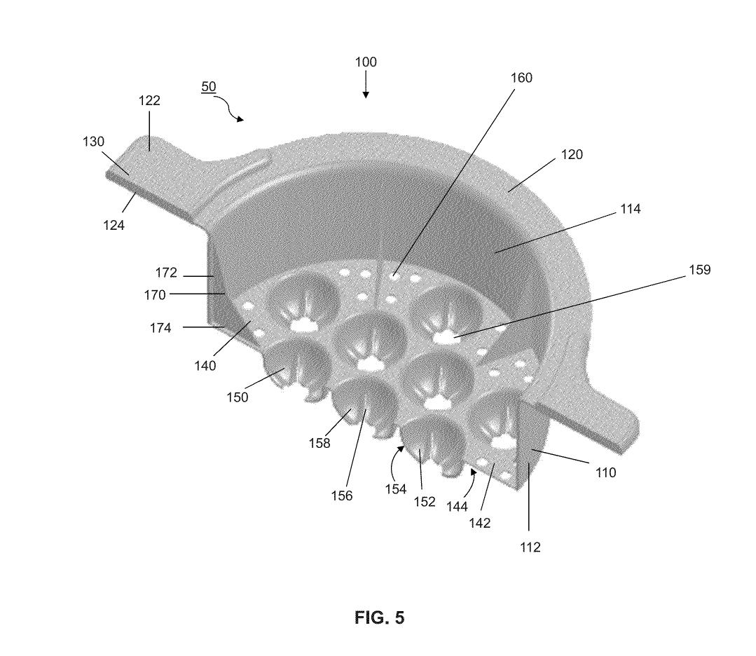

The securing components 150 each include an internal surface 152 and an external surface 154. As can be seen in FIG. 2 and FIG. 3, the surfaces 152, 154 of the securing component 150 comprise a portion of an ovoid or ovoid-shaped surface; however any shape or portion of a shape is contemplated for the securing component 150. As can be seen in at least FIG. 2 and FIG. 5, the surfaces 152, 154 extend below the exterior surface 144 of the base wall element 140.

The securing component 150 includes an opening 159 opposing the base wall element 140. Each securing component 150 also includes one or more slit elements 156. Each slit element 156 passes through both the internal surface 152 and the external surface 154. It is contemplated that each slit element 156 may extend up a portion of the surfaces 152, 154 toward the base wall element 140.

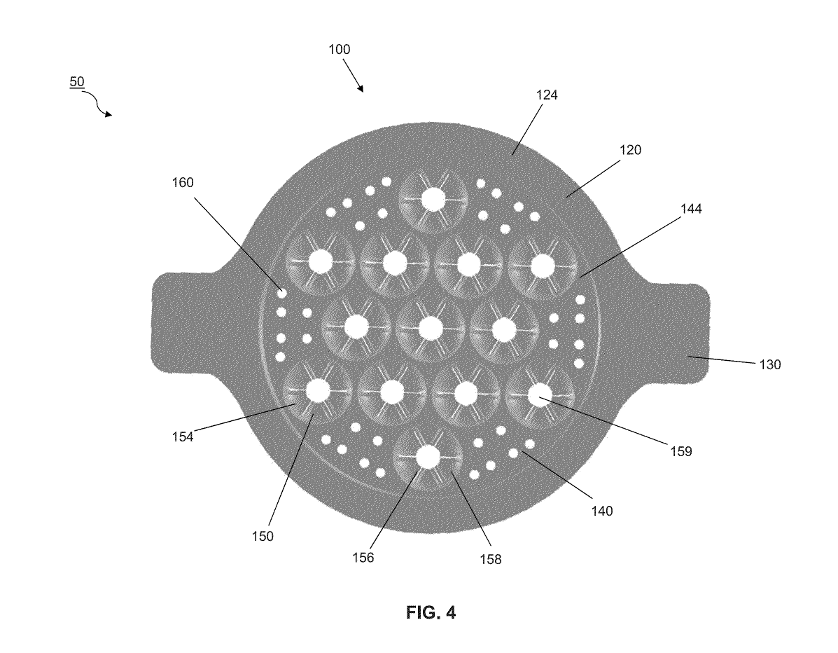

The slit elements 156 provide flexibility to the securing component 150 such that each securing component 150 is adjustable to accommodate eggs of various size and shape. More specifically, slit elements 156 form flexible tab elements 158 as shown in FIG. 3, FIG. 4 and FIG. 5. The flexible tab elements 158 allow the internal surface 152 of the securing component 150 to conform to eggs of various sizes and shapes. As can be further seen in FIG. 3, FIG. 4 and FIG. 5, tab elements 158 form an opening 159 within the securing component 150.

The base wall element 140 may further include one or more hole elements 160 for draining fluid from inside the body. As can be seen, hole element 160 extends through both the interior surface 142 and the exterior surface 144 of the base wall element 140. Although the hole elements 160 are shown, for example, in FIG. 5 as being generally circular in shape, any shape is contemplated such as square or triangular.

Certain embodiments of the invention may also include a support element 170 connected to both the side wall element 110 and the base wall element 140. Support elements strengthen the overall device 50 including, for example, to prevent side wall element 110 from collapsing such as from repeated exposure to heat. As shown in FIG. 1, FIG. 3 and FIG. 5, support element 170 includes a first edge 172 and a second edge 174. The first edge 172 is connected to the inner surface 114 of the side wall element 110 and the second edge 174 is connected to the interior surface 142 of the base wall element 140.

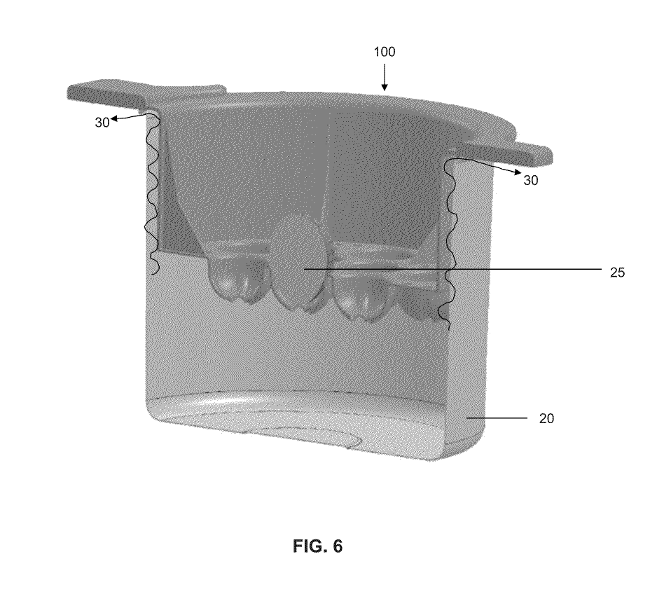

FIG. 6 illustrates a section view of the egg preparation assistance device 50 as used with a cooking apparatus in the form of a pot 20 according to the invention. According to one contemplated use of the invention, a user pre-loads eggs into the device 50 by positioning each egg 25 within a securing component 150. The user holds and maneuvers the device 50 such as by handle component 130 into a pot 20 including water. Specifically, handle component 130 is used to is position the device 50 such that the bottom surface 124 of the border element 120 rests on the top rim of the pot 20. This prevents the device 50 from being entirely submerged in hot water and ensures that the eggs 25 remain suspended within the pot 20 as shown in FIG. 6. According to the invention, the device 50 is positioned within a cooking apparatus such that steam is not prevented from escaping. For example, as shown in FIG. 6, steam 30 is allowed to escape between the top rim of the pot and the bottom surface 124 of the border element 120.

As the water is heated, such as to a boil at 100° C., the securing component 150 including tab element 158 and opening 159 allow the internal surface 152 of the securing component 150 to conform to the egg 25 and thereby prevent the egg 25 from floating to the top of the pot 20. Opening 159 in addition to hole elements 160 allow improved circulation of the water within the pot 20 during cooking.

Upon reaching the desired level of cooking, the device 50 may be removed from the pot of water such as by handle component 130. As the device 50 is removed from the pot 20, fluid drains from the one or more hole elements 160. The device 50 including cooked eggs may also be transferred such as under cool running water or placed within a refrigerator.

While the disclosure is susceptible to various modifications and alternative forms, specific exemplary embodiments of the invention have been shown by way of example in the drawings and have been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

1. An egg preparation assistance device, comprising:
a body comprising a side wall element connected to a base wall element,
the base wall element including one or more securing components for securing a portion of an egg within the body, each of the one or more securing components comprising one or more slit elements such that each securing component is adjustable to accommodate eggs of various configurations.

2. The egg preparation assistance device according to claim 1 further comprising a border element connected to the side wall element, the border element for placement of the egg preparation assistance device with a cooking apparatus.

3. The egg preparation assistance device according to claim 2, wherein the is border dement further comprises a handle component.

4. The egg preparation assistance device according to claim 2, wherein each of the one or more securing components comprises a portion of an ovoid-shaped surface.

5. The egg preparation assistance device according to claim 1, wherein the base wall element further includes one or more hole dements for draining fluid from inside the body.

6. The egg preparation assistance device according to claim 1 further comprising a support element connected to both the side wall element and the base wall element.

7. A device for use with cooking eggs, the device comprising:
a body including a side wall element, a border element, and a base wall element;
the side wall element including an outer surface and an inner surface,
the border element including a top surface and a bottom surface,
the base wall element including an interior surface and an exterior surface,
a handle component positioned on the top surface of the border element;
a securing component positioned on the base wall element, the securing component comprising an internal surface and an external surface with the surfaces configured as a portion of an ovoid and the surfaces extending below the exterior surface of the base wall element, the securing component further comprising:
a slit element passing through both the internal surface and the external surface to accommodate eggs of various configuration such that the internal surface of the securing component conforms to eggs of various size and shape, and
a hole element extending through both the interior surface and the exterior surface of the base wall element.

8. A device for use with cooking eggs according to claim 7, further comprising a second slit element.

9. A device for use with cooking eggs according to claim 8, further comprising a flexible tab dement formed by both the slit element and the second slit dement.

10. The egg preparation assistance device according to claim 7 further comprising a support element with a first edge and a second edge, the first edge connected to the inner surface of the side wall dement and the second edge connected to the interior surface of the base wall dement.
